(19) United States
(12) Patent Application Publication
(10) Pub. No.: US 2018/0255015 A1
(43) Pub. Date: Sep. 6, 2018

(54) WATCH-TYPE MOBILE TERMINAL AND CONTROL METHOD THEREFOR

(71) Applicant: LG ELECTRONICS INC., Seoul (KR)

(72) Inventor: Sohyun AHN, Seoul (KR)

(73) Assignee: LG ELECTRONICS INC., Seoul (KR)

(21) Appl. No.: 15/756,449

(22) PCT Filed: Sep. 24, 2015
(86) PCT No.: PCT/KR2015/010070

§ 371 Date: Feb. 28, 2018

(30) Foreign Application Priority Data
Sep. 2, 2015 (KR) 10-2015-0124451

(51) Int. Cl. H04L 12/58; G06F 3/0481; G06F 1/16

(52) U.S. Cl. CPC H04L 51/26; G06F 1/163; G06F 3/04817; H04L 51/24

(57) ABSTRACT

The present invention relates to a watch-type mobile terminal for outputting a notification object when an event occurs, and a control method therefor. According to the present invention, the watch-type mobile terminal comprises: a display unit for outputting a plurality of notification objects respectively corresponding to a plurality of events, on the basis of the occurrence of the plurality of events; and a control unit for sequentially ending the output of the plurality of notification objects on the basis of the priorities preset for the plurality of events.

### TECHNICAL FIELD

The present invention relates to a watch-type mobile terminal for outputting a notification object upon occurrence of an event and a method for controlling the same.

### BACKGROUND ART

Terminals may be divided into mobile/portable terminals and stationary terminals according to mobility. Also, the mobile terminals may be classified into handheld types and vehicle mount types according to whether or not a user can directly carry.

Mobile terminals have become increasingly more functional. Examples of such functions include data and voice communications, capturing images and video via a camera, recording audio, playing music files via a speaker system, and displaying images and video on a display unit. Some mobile terminals include additional functionality which supports electronic game playing, while other terminals are configured as multimedia players. Specifically, in recent time, mobile terminals can receive broadcast and multicast signals to allow viewing of video or television programs

As it becomes multifunctional, a mobile terminal can be allowed to capture still images or moving images, play music or video files, play games, receive broadcast and the like, so as to be implemented as an integrated multimedia player.

On the other hand, when a preset event occurs in the terminal, a notification icon or a notification menu may be displayed to inform the user of the event. Thereafter, when another event additionally occurs, the notification icon for the previously-occurred event disappears from a screen. As a result, occurrence of an important event may be missed.

Efforts are ongoing to support and increase the functionality of mobile terminals. Such efforts include software and hardware improvements, as well as changes and improvements in the structural components.

### DISCLOSURE OF THE INVENTION

The present invention is directed to solving the above-mentioned problems and other drawbacks. Another aspect of the present invention is to provide a watch-type mobile terminal, in which notification icons for event occurrence disappear according to preset priorities, and a control method thereof.

To achieve these and other aspects of the present invention, in accordance with one embodiment of the present invention, there is provided a watch-type mobile terminal, including a display unit configured to output a plurality of notification objects corresponding to a plurality of events, respectively, in response to occurrence of the plurality of events, and a controller configured to sequentially terminate the output of the plurality of notification objects based on priorities preset for the plurality of events.

In an embodiment, the controller may output at least one of preset vibration and notification sound at the same time of sequentially terminating the output of the plurality of notification objects.

In another embodiment, the controller may output only a notification object having a preset degree of priority, in response to a preset user input being applied.

In another embodiment, the controller may terminate the output of the plurality of notification objects at a time, in response to a preset user input being applied.

In another embodiment, when a preset touch input is applied to a first notification object as one of a plurality of notification objects corresponding to events occurred in a first application, the controller may arrange the remaining notification objects corresponding to the events occurred in the first application in a manner of being adjacent to the first notification object.

In another embodiment, the controller may arrange the plurality of notification objects according to applications in which the plurality of events have occurred, in response to a preset user input being applied.

In another embodiment, the controller may arrange the plurality of notification objects in the order of occurred time of each of the plurality of events, in response to a preset user input being applied.

In another embodiment, the controller may re-output at least one notification object whose output has been terminated due to a lapse of a preset time, in response to a preset user input being applied.

In another embodiment, the controller may output the plurality of notification objects in a preset manner based on priorities preset for the plurality of events.

In another embodiment, the controller may output a plurality of notification icons corresponding to a plurality of events for receiving data, in response to occurrence of the plurality of events.

In another embodiment, the controller may switch the plurality of notification icons into icons corresponding to originators who have sent the data, in response to a preset user input being applied.

In another embodiment, the controller may switch a notification icon corresponding to a data reception event from a specific originator into an icon corresponding to the specific originator, in response to a preset user input being applied.

In another embodiment, the controller may switch a notification icon corresponding to a data reception event occurred in a specific application into an icon corresponding to an originator who has sent the data, in response to a preset user input being applied.

In another embodiment, the controller may sequentially terminate the output of the plurality of notification icons based on priorities preset for the plurality of events.

In another embodiment, the controller may sequentially terminate the output of the plurality of notification icons based on at least one of a data originator, presence or absence of preset data, and occurrence or non-occurrence of an event in a preset application, with respect to the plurality of events.

In another embodiment, the controller may sequentially terminate the output of the plurality of notification icons, in response to a lapse of a preset time.

In another embodiment, the controller may sequentially terminate the output of the plurality of notification icons, in response to a preset user input being applied.

To achieve these and other aspects of the present invention, in accordance with one embodiment of the present invention, there is provided a method for controlling a watch-type mobile terminal, the method including (a) outputting a plurality of notification objects corresponding to a plurality of events, respectively, in response to occurrence of the plurality of events, and (b) sequentially terminating the output of the plurality of notification objects based on priorities preset for the plurality of events.

In an embodiment, the step (a) may include outputting a plurality of notification icons corresponding to a plurality of events for receiving data, respectively, in response to occurrence of the plurality of events.

In another embodiment, the step (b) may include sequentially terminating the output of the plurality of notification icons based on priorities preset for the plurality of events.

### Effects of the Invention

Hereinafter, effects of a mobile terminal and a method of controlling the same according to the present invention will be described.

According to at least one of the embodiments of the present invention, since event occurrence notification icons disappear based on their priorities, a user cannot miss important notification.

In addition, according to at least one of the embodiments of the present invention, as a message reception notification icon is switched into a photo image of a message originator, the message originator can be intuitively confirmed.

Further scope of applicability of the present invention will become apparent from the following detailed description. It should be understood, however, that the detailed description and specific examples, such as the preferred embodiment of the invention, are given by way of illustration only, since various changes and modifications within the spirit and scope of the invention will be apparent to those skilled in the art.

### BRIEF DESCRIPTION OF THE DRAWINGS

FIG. 1A is a block diagram of a mobile terminal in accordance with one exemplary embodiment of the present invention.

FIGS. 1B and 10 are conceptual views illustrating one example of a mobile terminal according to the present invention, viewed from different directions.

FIG. 2 is a perspective view illustrating an example of a watch-type mobile terminal according to another embodiment of the present invention.

FIG. 3 is a flowchart illustrating a control method of a watch-type mobile terminal according to the present invention.

FIG. 4 is a conceptual view illustrating an embodiment in which only a notification icon having a high priority is left, in response to a preset gesture.

FIG. 5 is a conceptual view illustrating an embodiment in which all notification icons are deleted, in response to a preset touch input.

FIG. 6 is a conceptual view illustrating another embodiment in which all notification icons are deleted, in response to a preset touch input.

FIG. 7 is a conceptual view illustrating an embodiment in which specific notification icons are arranged close to each other, in response to a preset touch input.

FIG. 8 is a conceptual view illustrating an embodiment in which notification icons are arranged for each application in which an event occurs, in response to a preset touch input.

FIG. 9 is a conceptual view illustrating an embodiment in which notification icons are arranged according to a time at which an event occurs, in response to a preset touch input.

FIG. 10 is a conceptual view illustrating an embodiment in which deleted notification icons are output again, in response to a preset touch input.

FIG. 11 is a conceptual view illustrating an embodiment in which notification icons are output in a preset manner based on priorities.

FIG. 12 is a conceptual view illustrating an embodiment in which contents of occurred events are output based on priorities.

FIG. 13 is a conceptual view illustrating an embodiment in which a photograph of a message sender is output, in response to a preset user input.

FIG. 14 is a conceptual view illustrating an embodiment in which a data reception notification icon from a specific sender is switched to a photograph of the specific sender, in response to a preset touch input.

FIG. 15 is a conceptual view illustrating an embodiment in which a data reception notification icon in a specific application is switched to a photograph of an originator, in response to a preset touch input.

FIG. 16 is a conceptual view illustrating an embodiment in which a notification menu disappears based on a number of occurrences of data reception events.

FIG. 17 is a conceptual view illustrating an embodiment in which a notification menu disappears based on a priority of an originator.

FIG. 18 is a conceptual view illustrating an embodiment in which only a notification menu of an event generated in a specific application is left.

FIG. 19 is a conceptual view illustrating an embodiment in which only a notification menu of data reception including a specific word is left.

FIG. 20 is a conceptual view illustrating an embodiment in which a notification menu disappears in response to contents of received data being confirmed.

FIG. 21 is a conceptual view illustrating an embodiment in which a currently-output notification menu disappears only from a watch-type mobile terminal, in response to an input of a preset touch input.

FIG. 22 is a conceptual view illustrating an embodiment in which a currently-output notification menu disappears from a watch-type mobile terminal and a smart phone, in response to an input of a preset touch input.

FIG. 23 is a conceptual view illustrating an embodiment in which a currently-output notification menu disappears in response to a preset touch input.

### BEST MODE OF THE INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

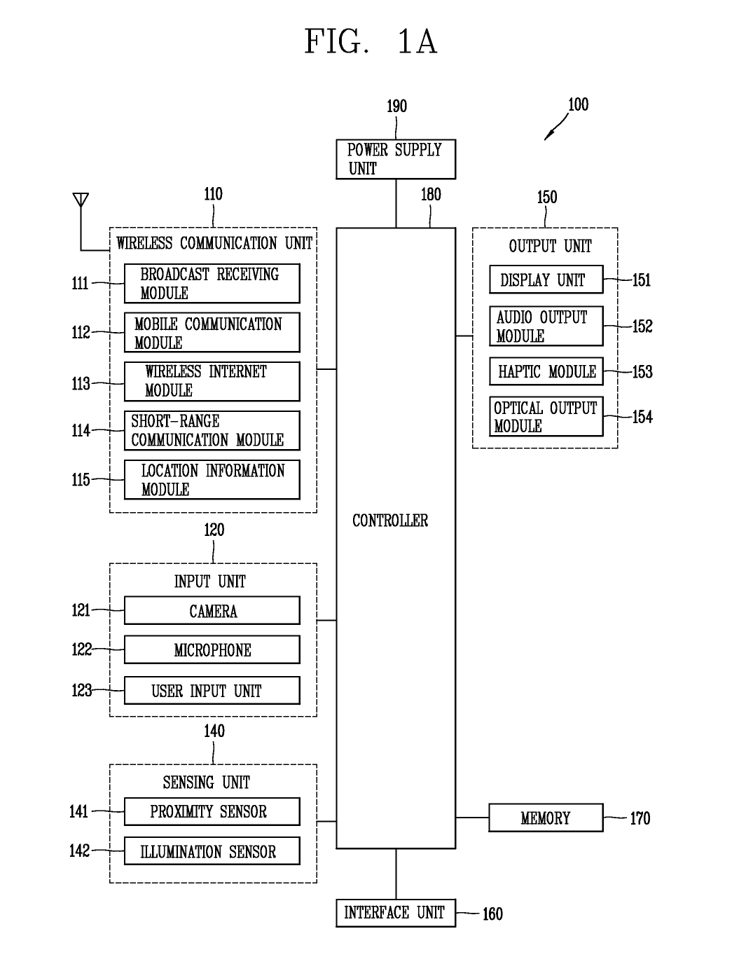

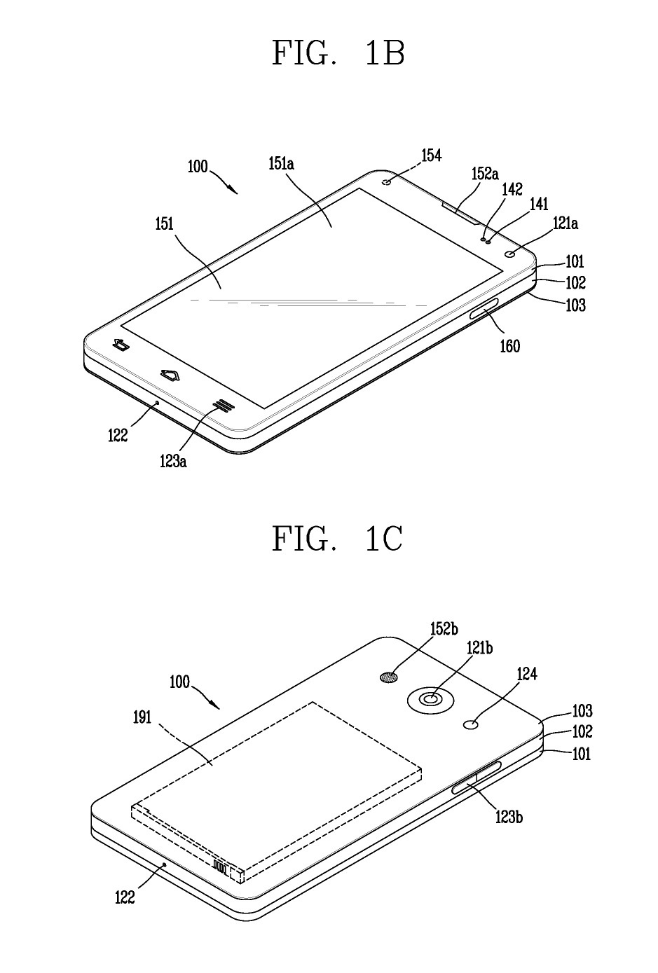

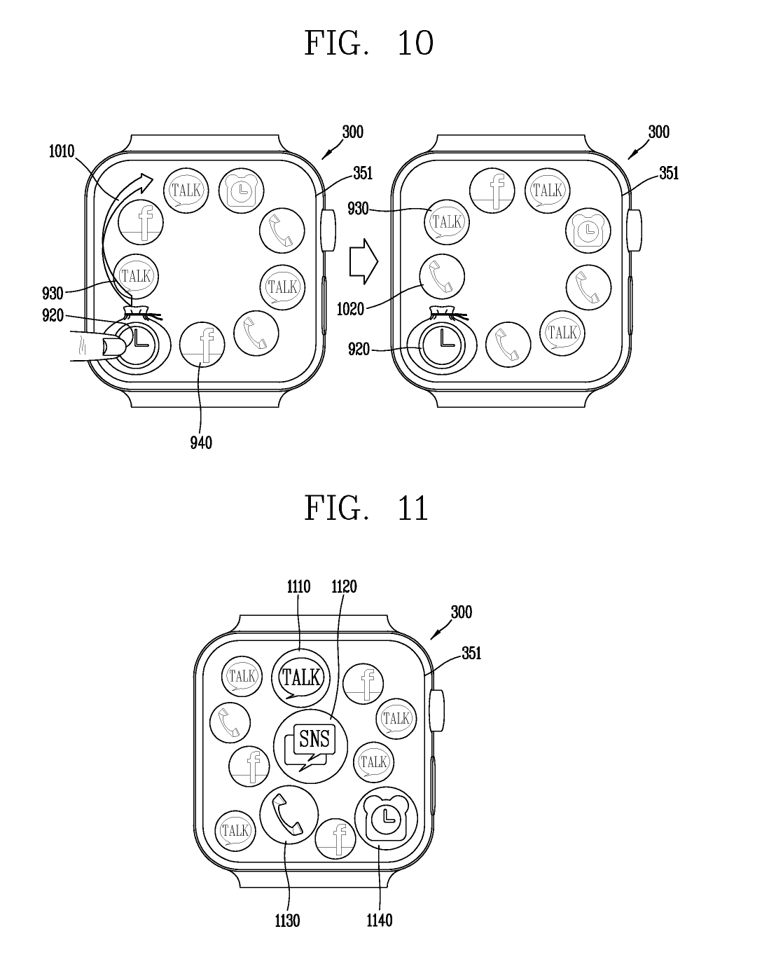

Referring to FIGS. 1A to 10, FIG. 1A is a block diagram of a mobile terminal in accordance with one exemplary embodiment of the present invention, and FIGS. 1B and 10 are conceptual views illustrating one example of a mobile terminal, viewed from different directions.

The mobile terminal 100 may be shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

In more detail, the wireless communication unit 110 may typically include one or more modules which permit communications such as wireless communications between the mobile terminal 100 and a wireless communication system, communications between the mobile terminal 100 and another mobile terminal, or communications between the mobile terminal 100 and an external server. Further, the wireless communication unit 110 may typically include one or more modules which connect the mobile terminal 100 to one or more networks.

The wireless communication unit 110 may include one or more of a broadcast receiving module 111, a mobile communication module 112, a wireless Internet module 113, a short-range communication module 114, and a location information module 115.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the mobile terminal, the surrounding environment of the mobile terminal, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The mobile terminal disclosed herein may be configured to utilize information obtained from one or more sensors of the sensing unit 140, and combinations thereof.

The output unit 150 may typically be configured to output various types of information, such as audio, video, tactile output, and the like. The output unit 150 may be shown having at least one of a display unit 151, an audio output module 152, a haptic module 153, and an optical output module 154. The display unit 151 may have an inter-layered structure or an integrated structure with a touch sensor in order to implement a touch screen. The touch screen may function as the user input unit 123 which provides an input interface between the mobile terminal 100 and the user and simultaneously provide an output interface between the mobile terminal 100 and a user.

The interface unit 160 serves as an interface with various types of external devices that are coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). Application programs may be stored in the memory 170, installed in the mobile terminal 100, and executed by the controller 180 to perform an operation (or function) for the mobile terminal 100.

The controller 180 typically functions to control an overall operation of the mobile terminal 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 may control at least some of the components illustrated in FIG. 1A, to execute an application program that have been stored in the memory 170. In addition, the controller 180 may control at least two of those components included in the mobile terminal to activate the application program.

The power supply unit 190 may be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least part of the components may cooperatively operate to implement an operation, a control or a control method of a mobile terminal according to various embodiments disclosed herein. Also, the operation, the control or the control method of the mobile terminal may be implemented on the mobile terminal by an activation of at least one application program stored in the memory 170.

Hereinafter, description will be given in more detail of the aforementioned components with reference to FIG. 1A, prior to describing various embodiments implemented through the mobile terminal 100.

First, regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules may be utilized to facilitate simultaneous reception of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), High Speed Uplink Packet Access (HSUPA), Long Term Evolution (LTE), Long Term Evolution-Advanced (LTE-A), and the like).

The wireless signal may include various types of data depending on a voice call signal, a video call signal, or a text/multimedia message transmission/reception.

The wireless Internet module 113 refers to a module for wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-advanced (LTE-A) and the like. The wireless Internet module 113 may transmit/receive data according to one or more of such wireless Internet technologies, and other Internet technologies as well.

When the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

Here, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of at least part of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position (or current position) of the mobile terminal. As an example, the location information module 115 includes a Global Position System (GPS) module, a Wi-Fi module, or both. For example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module. If desired, the location information module 115 may alternatively or additionally function with any of the other modules of the wireless communication unit 110 to obtain data related to the position of the mobile terminal. The location information module 115 is a module used for acquiring the position (or the current position) and may not be limited to a module for directly calculating or acquiring the position of the mobile terminal.

Examples of such inputs include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. Meanwhile, the cameras 121 may be arranged in a matrix configuration to permit a plurality of images having various angles or focal points to be input to the mobile terminal 100. Also, the cameras 121 may be located in a stereoscopic arrangement to acquire left and right images for implementing a stereoscopic image.

The microphone 122 processes an external audio signal into electric audio (sound) data. The processed audio data can be processed in various manners according to a function being executed in the mobile terminal 100. If desired, the microphone 122 may include assorted noise removing algorithms to remove unwanted noise generated in the course of receiving the external audio signal.

The user input unit 123 is a component that permits input by a user. Such user input may enable the controller 180 to control operation of the mobile terminal 100. The user input unit 123 may include one or more of a mechanical input element (for example, a mechanical key, a button located on a front and/or rear surface or a side surface of the mobile terminal 100, a dome switch, a jog wheel, a jog switch, and the like), or a touch-sensitive input element, among others. As one example, the touch-sensitive input element may be a virtual key, a soft key or a visual key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like, and generate a corresponding sensing signal. The controller 180 generally cooperates with the sending unit 140 to control operations of the mobile terminal 100 or execute data processing, a function or an operation associated with an application program installed in the mobile terminal based on the sensing signal. The sensing unit 140 may be implemented using any of a variety of sensors, some of which will now be described in more detail.

The proximity sensor 141 refers to a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data (or information) according to whether a touch with respect to a point on the touch screen is either a proximity touch or a contact touch.

A touch sensor can sense a touch (or a touch input) applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

Meanwhile, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

Meanwhile, the touch sensor may be configured to detect the touch input using different methods in the activated and deactivated states of the display unit 151. In this instance, the different method may be related to an activation period of the touch sensor. More specifically, the touch sensor may be activated at a different period according to whether the display unit 151 has been activated or not. That is, the touch sensor may have a different activation period according to whether the display unit 151 has been activated or not, and may sense a touch input applied thereto.

For instance, in a deactivated state of the display unit 151, the touch sensor may be activated with a preset period. In this instance, the preset period may be a time period more than 0. Further, in an activated state of the display unit 151, the touch sensor may be always operated in an activated state. In this instance, an activation period of the touch sensor may be ‘0’ or a value very close to ‘0’.

Whether the touch sensor is in an activated state or a deactivated state may be determined based on a power consumption amount of the touch sensor. For instance, if a power consumption amount of the touch sensor is equal to or less than a preset value based on ‘0’, it may be determined that the touch sensor is in a deactivated state. Further, if a power consumption amount of the touch sensor exceeds the preset value based on ‘0’, it may be determined that the touch sensor is in an activated state.

If the display unit 151 is in an activated state (hereinafter, will be referred to as an active mode), the touch sensor may wait for touch inputs onto the display unit 151, while maintaining an activated state. Further, if the display unit 151 is in a deactivated state (hereinafter, will be referred to as a doze mode), the touch sensor may be activated at preset periods.

When the preset period of the touch sensor is shorter, a sensing speed with respect to touch inputs applied onto the display unit 151 is higher. However, in this instance, a power consumption amount of the touch sensor may be increased. In contrast, when the preset period of the touch sensor is longer, a sensing speed with respect to touch inputs applied onto the display unit 151 may be lower, while a power consumption amount of the touch sensor is decreased.

Thus, the preset period may be set so that a sensing speed with respect to taps applied onto the display unit 151 is high enough not to be recognized by a user, and so that power consumption can be reduced. For instance, the preset period may be set so that the touch sensor in a deactivated state can be activated about 20 times (1 Hz) per second.

While the display unit 151 is in an activated state, the touch sensor may be also in an activated state. In an activated state, the touch sensor may have an activation period (T) of ‘0’ or a value very close to ‘0’. Alternatively, in an activated state, the touch sensor may have an activation period (T) much shorter than that set in a deactivated state of the display unit 151, by several times. That is, the touch sensor may be activated with a different period, according to whether the display unit 151 is in an activated state or a deactivated state.

In a doze mode where the display unit 151 is in a doze state and the touch sensor is periodically activated, if a preset touch input (e.g., a first touch input and a second touch input consecutively knocking-on a predetermined region within a predetermined time) is sensed by the touch sensor, the controller 180 can convert the doze mode into an active mode where the flexible display unit and the touch sensor are activated.

The touch sensor may be driven at a different period based on a state of the display unit 151. For instance, when the display unit 151 is in a closed state, a doze mode may be executed. Further, when a closed state is converted into an open state, an active mode may be executed.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize location information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121, which has been depicted as a component of the input unit 120, typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors (TRs) at rows and columns to scan content received at the photo sensor using an electrical signal which changes according to the quantity of applied light. Namely, the photo sensor may calculate the coordinates of the physical object according to variation of light to thus obtain location information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

Also, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 may receive audio data from the wireless communication unit 110 or output audio data stored in the memory 170 during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceives, or otherwise experiences. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal therethrough. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a flash memory type, a hard disk type, a solid state disk (SSD) type, a silicon disk drive (SDD) type, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control operations relating to application programs and the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100 under the control of the controller 180. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring to FIGS. 1B and 10, the disclosed mobile terminal 100 includes a bar-like terminal body. However, the mobile terminal 100 may alternatively be implemented in any of a variety of different configurations. Examples of such configurations include watch type, clip-type, glasses-type, or a folder-type, flip-type, slide-type, swing-type, and swivel-type in which two and more bodies are combined with each other in a relatively movable manner, and combinations thereof. Discussion herein will often relate to a particular type of mobile terminal. However, such teachings with regard to a particular type of mobile terminal will generally apply to other types of mobile terminals as well.

Here, considering the mobile terminal 100 as at least one assembly, the terminal body may be understood as a conception referring to the assembly.

The mobile terminal 100 will generally include a case (for example, frame, housing, cover, and the like) forming the appearance of the terminal. In this embodiment, the case is formed using a front case 101 and a rear case 102. Various electronic components are interposed into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. In this case, a rear cover 103 is shown covering the electronic components, and this cover may be detachably coupled to the rear case 102. Therefore, when the rear cover 103 is detached from the rear case 102, the electronic components mounted on the rear case 102 are exposed to the outside.

As illustrated, when the rear cover 103 is coupled to the rear case 102, a side surface of the rear case 102 may partially be exposed. In some cases, upon the coupling, the rear case 102 may also be completely shielded by the rear cover 103. Meanwhile, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this case, a mobile terminal 100 having a uni-body is formed in such a manner that synthetic resin or metal extends from a side surface to a rear surface.

Meanwhile, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include a display unit 151, first and second audio output module 152a and 152b, a proximity sensor 141, an illumination sensor 142, an optical output module 154, first and second cameras 121a and 121b, first and second manipulation units 123a and 123b, a microphone 122, an interface unit 160, and the like.

Hereinafter, as illustrated in FIGS. 1B and 10, description will be given of the exemplary mobile terminal 100 in which the front surface of the terminal body is shown having the display unit 151, the first audio output module 152a, the proximity sensor 141, the illumination sensor 142, the optical output module 154, the first camera 121a, and the first manipulation unit 123a, the side surface of the terminal body is shown having the second manipulation unit 123b, the microphone 122, and the interface unit 160, and the rear surface of the terminal body is shown having the second audio output module 152b and the second camera 121b.

However, those components may not be limited to the arrangement. Some components may be omitted or rearranged or located on different surfaces. For example, the first manipulation unit 123a may be located on another surface of the terminal body, and the second audio output module 152b may be located on the side surface of the terminal body other than the rear surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display module 151 may include at least one of a liquid crystal display (LCD), a thin film transistor-LCD (TFT LCD), an organic light-emitting diode (OLED), a flexible display, a three-dimensional (3D) display and an e-ink display.

The display unit 151 may be implemented using two display devices, according to the configuration type thereof. For instance, a plurality of the display units 151 may be arranged on one side, either spaced apart from each other, or these devices may be integrated, or these devices may be arranged on different surfaces.

The display unit 151 may include a touch sensor that senses a touch with respect to the display unit 151 so as to receive a control command in a touch manner. Accordingly, when a touch is applied to the display unit 151, the touch sensor may sense the touch, and a controller 180 may generate a control command corresponding to the touch. Contents input in the touch manner may be characters, numbers, instructions in various modes, or a menu item that can be specified.

On the other hand, the touch sensor may be configured in a form of a film having a touch pattern and disposed between a window 151a and a display (not illustrated) on a rear surface of the window, or may be a metal wire directly patterned on the rear surface of the window. Alternatively, the touch sensor may be formed integrally with the display. For example, the touch sensor may be disposed on a substrate of the display, or may be provided inside the display.

In this way, the display unit 151 may form a touch screen together with the touch sensor, and in this case, the touch screen may function as the user input unit (123, see FIG. 1A). In some cases, the touch screen may replace at least some of functions of a first manipulation unit 123a.

The first audio output module 152a may be implemented as a receiver for transmitting a call sound to a user's ear and the second audio output module 152b may be implemented as a loud speaker for outputting various alarm sounds or multimedia playback sounds.

The window 151a of the display unit 151 may include a sound hole for emitting sounds generated from the first audio output module 152a. However, the present invention is not limited thereto, and the sounds may be released along an assembly gap between the structural bodies (for example, a gap between the window 151a and the front case 101). In this case, a hole independently formed to output audio sounds may not be seen or may otherwise be hidden in terms of appearance, thereby further simplifying the appearance of the mobile terminal 100.

The optical output module 154 may be configured to output light for indicating an event generation. Examples of such events may include a message reception, a call signal reception, a missed call, an alarm, a schedule alarm, an email reception, information reception through an application, and the like. When a user has checked a generated event, the controller 180 may control the optical output module 154 to stop the light output.

The first camera 121a may process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion. The first and second manipulation units 123a and 123b may employ any method if it is a tactile manner allowing the user to perform manipulation with a tactile feeling such as touch, push, scroll or the like The first and second manipulation units 123a and 123b may also be manipulated through a proximity touch, a hovering touch, and the like, without a user's tactile feeling.

The drawings are illustrated on the basis that the first manipulation unit 123a is a touch key, but the present disclosure may not be necessarily limited to this. For example, the first manipulation unit 123a may be configured with a mechanical key, or a combination of a touch key and a push key.

The content received by the first and second manipulation units 123a and 123b may be set in various ways. For example, the first manipulation unit 123a may be used by the user to input a command such as menu, home key, cancel, search, or the like, and the second manipulation unit 123b may be used by the user to input a command, such as controlling a volume level being output from the first or second audio output module 152a or 152b, switching into a touch recognition mode of the display unit 151, or the like.

On the other hand, as another example of the user input unit 123, a rear input unit (not shown) may be disposed on the rear surface of the terminal body. The rear input unit may be manipulated by a user to input a command for controlling an operation of the mobile terminal 100. The content input may be set in various ways. For example, the rear input unit may be used by the user to input a command, such as power on/off, start, end, scroll or the like, controlling a volume level being output from the first or second audio output module 152a or 152b, switching into a touch recognition mode of the display unit 151, or the like. The rear input unit may be implemented into a form allowing a touch input, a push input or a combination thereof.

The rear input unit may be disposed to overlap the display unit 151 of the front surface in a thickness direction of the terminal body. As one example, the rear input unit may be disposed on an upper end portion of the rear surface of the terminal body such that a user can easily manipulate it using a forefinger when the user grabs the terminal body with one hand. However, the present disclosure may not be limited to this, and the position of the rear input unit may be changeable.

When the rear input unit is disposed on the rear surface of the terminal body, a new user interface may be implemented using the rear input unit. Also, the aforementioned touch screen or the rear input unit may substitute for at least part of functions of the first manipulation unit 123a located on the front surface of the terminal body. Accordingly, when the first manipulation unit 123a is not disposed on the front surface of the terminal body, the display unit 151 may be implemented to have a larger screen.

On the other hand, the mobile terminal 100 may include a finger scan sensor which scans a user's fingerprint. The controller may use fingerprint information sensed by the finger scan sensor as an authentication means. The finger scan sensor may be installed in the display unit 151 or the user input unit 123.

The microphone 122 may be configured to receive the user's voice, other sounds, and the like. The microphone 122 may be provided at a plurality of places, and configured to receive stereo sounds.

The interface unit 160 may serve as a path allowing the mobile terminal 100 to interface with external devices. For example, the interface unit 160 may be at least one of a connection terminal for connecting to another device (for example, an earphone, an external speaker, or the like), a port for near field communication (for example, an Infrared DaAssociation (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b may be further mounted to the rear surface of the terminal body. The second camera 121b may have an image capturing direction, which is substantially opposite to the direction of the first camera unit 121a.

The second camera 121b may include a plurality of lenses arranged along at least one line. The plurality of lenses may be arranged in a matrix form. The cameras may be referred to as an ‘array camera.’ When the second camera 121b is implemented as the array camera, images may be captured in various manners using the plurality of lenses and images with better qualities may be obtained.

The flash 124 may be disposed adjacent to the second camera 121b. When an image of a subject is captured with the camera 121b, the flash 124 may illuminate the subject.

The second audio output module 152b may further be disposed on the terminal body. The second audio output module 152b may implement stereophonic sound functions in conjunction with the first audio output module 152a, and may be also used for implementing a speaker phone mode for call communication.

At least one antenna for wireless communication may be disposed on the terminal body. The antenna may be embedded in the terminal body or formed in the case. For example, an antenna which configures a part of the broadcast receiving module 111 (see FIG. 1A) may be retractable into the terminal body. Alternatively, an antenna may be formed in a form of film to be attached onto an inner surface of the rear cover 103 or a case including a conductive material may serve as an antenna.

The terminal body is provided with a power supply unit 190 (see FIG. 1A) for supplying power to the mobile terminal 100. The power supply unit 190 may include a batter 191 which is mounted in the terminal body or detachably coupled to an outside of the terminal body.

The battery 191 may receive power via a power cable connected to the interface unit 160. Also, the battery 191 may be (re)chargeable in a wireless manner using a wireless charger. The wireless charging may be implemented by magnetic induction or electromagnetic resonance.

On the other hand, the drawing illustrates that the rear cover 103 is coupled to the rear case 102 for shielding the battery 191, so as to prevent separation of the battery 191 and protect the battery 191 from an external impact or foreign materials. When the battery 191 is detachable from the terminal body, the rear case 103 may be detachably coupled to the rear case 102.

An accessory for protecting an appearance or assisting or extending the functions of the mobile terminal 100 may further be provided on the mobile terminal 100. As one example of the accessory, a cover or pouch for covering or accommodating at least one surface of the mobile terminal 100 may be provided. The cover or pouch may cooperate with the display unit 151 to extend the function of the mobile terminal 100. Another example of the accessory may be a touch pen for assisting or extending a touch input onto a touch screen.

On the other hand, the mobile terminal may extend to a wearable device which can be worn on a human body, beyond a typical manner of the user grasping the terminal with his hand. Examples of such wearable devices include smart watches, smart glasses, head mounted displays (HMDs), and the like. Hereinafter, examples of a mobile terminal extended to a wearable device will be described.

The wearable device can exchange data with (or cooperate with) another mobile terminal 100. The short-range communication module 114 may sense or recognize the wearable device that is near-enough to communicate with the mobile terminal 100. In addition, when the sensed wearable device is a device which is authenticated to communicate with the mobile terminal 100, the controller 180 may transmit at least part of data processed in the mobile terminal 100 to the wearable device via the short-range communication module 114, for example. Hence, the user of the wearable device can use the data processed in the mobile terminal 100 on the wearable device. For example, when a call is received in the mobile terminal 100, the user may answer the call using the wearable device. Also, when a message is received in the mobile terminal 100, the user can confirm the received message using the wearable device.

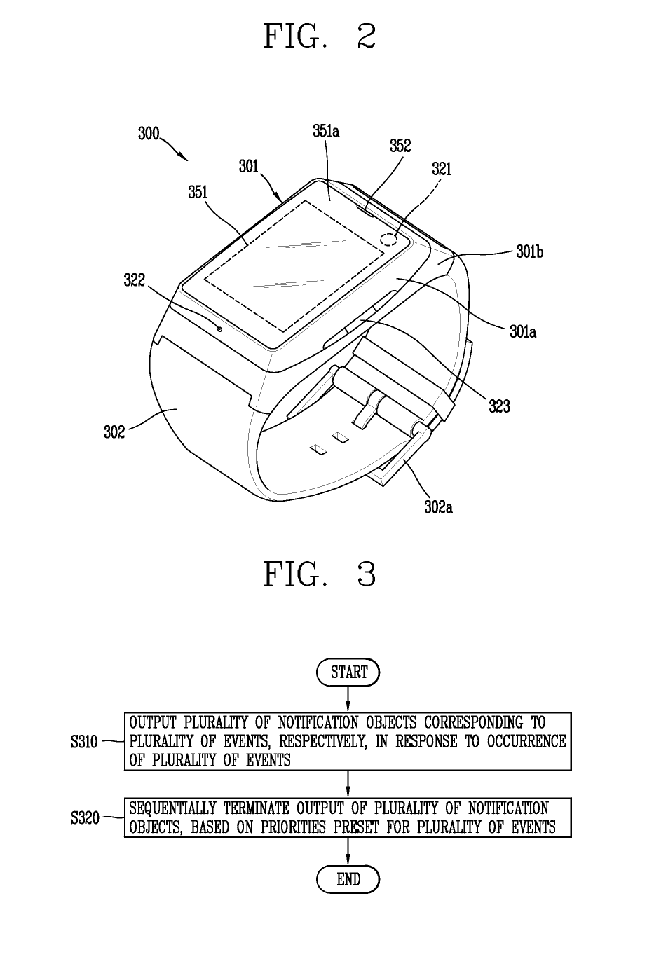

FIG. 2 is a perspective view illustrating an example of a watch-type mobile terminal 300 according to another embodiment of the present invention.

Referring to FIG. 2, a watch-type mobile terminal 300 includes a main body 301 having a display unit 351, and a band 302 connected to the main body 301 and configured to be worn on a wrist. In general, the mobile terminal 300 may include the same/like features of the mobile terminal 100 of FIGS. 1A to 10.

The main body 301 includes a case which defines appearance. As illustrated, the case may include a first case 301a and a second case 301b cooperatively defining an inner space for accommodating various electronic components. However, the present invention is not limited to this, and one case may be configured to define the inner space, thereby implementing a mobile terminal 300 with a uni-body.

The watch-type mobile terminal 300 can perform wireless communication, and an antenna for the wireless communication can be installed in the main body 301. On the other hand, the antenna may extend its function using the case. For example, a case including a conductive material may be electrically connected to the antenna to extend a ground area or a radiation area.

The display unit 351 may be disposed on a front surface of the main body 301 to output information, and a touch sensor may be provided on the display unit 351 to implement a touch screen. As illustrated, a window 351a of the display unit 351 may be mounted on the front case 101 to form the front surface of the terminal body together with the front case 101.

The main body 301 may include an audio output unit 352, a camera 321, a microphone 322, a user input unit 323, and the like. When the display unit 351 is implemented as the touch screen, the display unit 351 may function as a user input unit 323, so that the main body 301 may not have a separate key.

The band 302 may be worn on the wrist so as to surround the wrist, and may be formed of a flexible material for easy wearing. As an example, the band 302 may be formed of leather, rubber, silicone, synthetic resin, or the like. The band 302 may be detachably attached to the main body 301, and may be configured to be replaceable with various types of bands according to the user's preference.

On the other hand, the band 302 may be used to extend the performance of the antenna. For example, the band may include a ground extending portion (not illustrated) that is electrically connected to the antenna and extends a ground region.

The band 302 may be provided with a fastener 302a. The fastener 302a may be embodied by a buckle type, a snap-fit hook structure, a Velcro® type, or the like, and include a flexible section or material. The drawing illustrates an example that the fastener 302a is implemented using a buckle.

Hereinafter, embodiments related to a control method that can be implemented in a mobile terminal configured as above will be described with reference to the accompanying drawings. It will be apparent to those skilled in the art that the present invention may be embodied in other specific forms without departing from the spirit or essential characteristics thereof.

FIG. 3 is a flowchart illustrating a control method of a watch-type mobile terminal according to the present invention.

Referring to FIG. 3, a plurality of notification objects corresponding to a plurality of events are output, in response to occurrence of the plurality of events (S310).

Examples of such occurred events may include a message reception, a call signal reception, a missed call, an alarm, a schedule alarm, an email reception, an information reception through an application, and the like.

Also, the notification object refers to an object output on the display unit 351 to inform the user of occurrence of an event. For example, the notification objects may be a notification icon to be output when a message is received, a notification menu to be output when a missed call is generated, and the like.

Thereafter, the output of the plurality of notification objects is sequentially terminated based on priorities preset for the plurality of events.

The priorities may be set by the user or by a specific rule. Based on the priorities, the notification objects currently output on the display unit 351 disappear.

As an embodiment, the priorities may be set based on message originators (senders).

Specifically, when a message received from A has the highest priority, messages from B and C may be received after receiving the message from A. Accordingly, message reception icons indicating that those messages have been received from A, B and C may be output, respectively.

Thereafter, when a preset time has elapsed, the message reception icons indicating the messages received from B and C first disappear from the screen 351. On the other hand, the message reception icon indicating the message received from A may be continuously output on the screen 351. That is, irrespective of message-received times, those message reception icons disappear based on the preset priorities.

Hereinafter, detailed embodiments will be described.

As an embodiment, the step S310 may include outputting a plurality of notification icons respectively corresponding to a plurality of events of receiving data, in response to occurrence of the plurality of events.

As another embodiment, the step S320 may include sequentially terminating the output of the plurality of notification icons based on priorities preset for the plurality of events.

Hereinafter, description will be given of a specific embodiment with respect to the components of the watch-type mobile terminal 300.

The display unit 351 may output a plurality of notification objects corresponding to a plurality of events, in response to occurrence of the plurality of events.

The controller 180 may sequentially terminate the output of the plurality of notification objects based on priorities preset for the plurality of events.

In an embodiment, the controller 180 may sequentially terminate the output of the plurality of notification objects and simultaneously output at least one of preset vibration and notification sound.

In another embodiment, the controller 180 may output only a notification object having a preset degree of priority, in response to a preset user input being applied.

In another embodiment, the controller 180 may terminate the output of the plurality of notification objects at a time, in response to a preset user input being applied.

In another embodiment, when a preset touch input is applied to a first notification object as one of a plurality of notification objects corresponding to events occurred in a first application, the controller 180 may arrange the remaining notification objects corresponding to the events occurred in the first application in a manner of being adjacent to the first notification object.

In another embodiment, the controller 180 may arrange the plurality of notification objects according to the application in which the plurality of events have been generated, in response to a preset user input being applied.

In another embodiment, the controller 180 may arrange the plurality of notification objects according to a time order in which the plurality of events have occurred, in response to a preset user input being applied.

In another embodiment, the controller 180 may output at least one notification object of which output has been terminated due to a lapse of a preset time, in response to a preset user input being applied.

In another embodiment, the controller 180 may output the plurality of notification objects in a preset manner based on the priorities preset for the plurality of events.

In another embodiment, the controller 180 may output a plurality of notification icons corresponding to a plurality of events of receiving data, respectively, in response to the occurrence of the plurality of events.

In another embodiment, the controller 180 may switch the plurality of notification icons into icons corresponding to originators who have sent data, in response to a preset user input being applied.

In another embodiment, the controller 180 may switch a notification icon corresponding to a data reception event from a specific originator into an icon corresponding to the specific originator, in response to a preset user input being applied.

In another embodiment, the controller 180 may switch a notification icon corresponding to a data reception data occurred in a specific application into an icon corresponding to an originator who has sent the data, in response to a preset user input being applied.

In another embodiment, the controller 180 may sequentially terminate the output the plurality of notification icons based on the priorities preset for the plurality of events.

In another embodiment, the controller 180 may sequentially terminate the output of the plurality of notification icons, based on at least one of data originators for the plurality of events, presence or absence of preset data, and occurrence or non-occurrence in a preset application.

In another embodiment, the controller 180 may sequentially terminate the output of the plurality of notification icons in response to a lapse of a preset time.

In another embodiment, the controller 180 may sequentially terminate the output of the plurality of notification icons, in response to a preset user input being applied.

Meanwhile, the controller 180 may sequentially terminate the output of the plurality of notification objects and simultaneously output at least one of preset vibration and notification sound.

Also, the controller 180 may output only a notification object having a preset degree of priority, in response to a preset user input being applied.

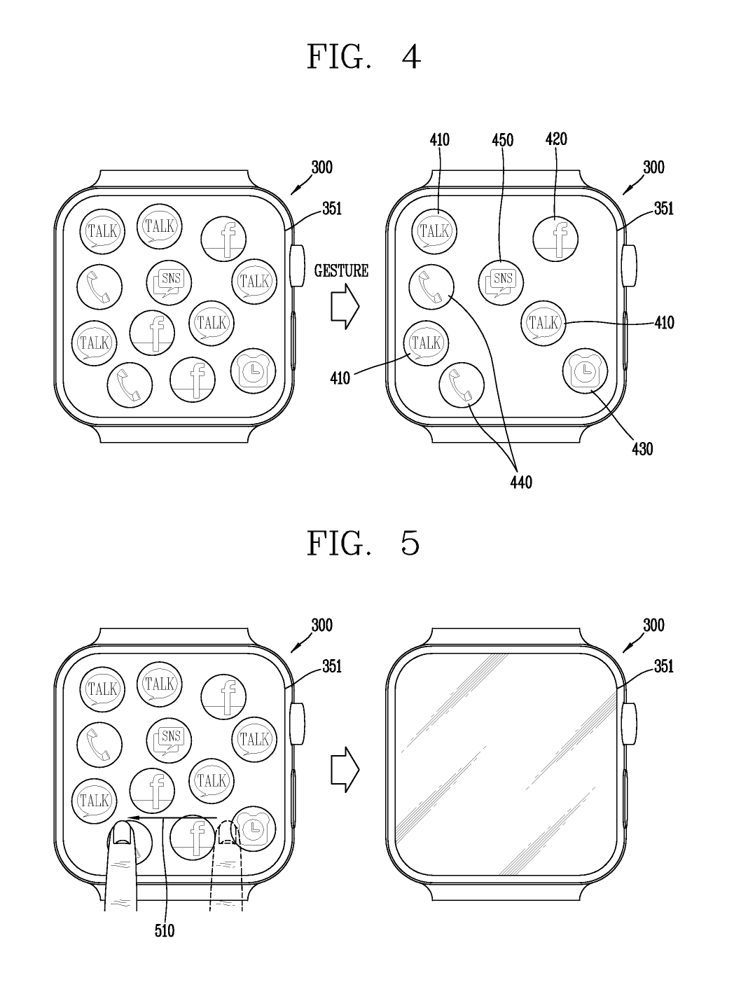

FIG. 4 is a conceptual view illustrating an embodiment in which only a notification icon having a high priority is left, in response to a preset gesture.

Referring to FIG. 4, when events such as a reception of a messenger message, a missed call, an alarm, a reception of an SNS message, and a comment received on an SNS occur, icons corresponding to the respective events may be displayed on the screen 351.

Specifically, the icons may be output at the same time as those events occur. At this time, vibration or notification sound notifying the occurrence of the events may be output together with the icons.

Then, when a preset gesture is applied, for example, when the user shakes the wrist wearing the watch-type mobile terminal 300 to the left or right, only an icon corresponding to an event having a preset degree of priority may be output.

As an embodiment, a messenger message reception notification icon 410 from a specific originator, a posting notification icon 420 of a user with a specific ID in an SNS, an alarm time notification icon 430, a missed call notification icon 440 from a specific originator, and an SNS message reception notification icon 450 may be merely output.

That is, the other icons having low priorities disappear from the screen 351. At this time, a predetermined degree of vibration or notification sound may be output together. As an embodiment, stronger vibration or louder notification sound may be output as more icons disappear from the screen 351.

In another embodiment, when a preset time has elapsed or a preset number of event notification objects or more are output, only icons corresponding to events having a preset degree of priority may be output.

On the other hand, the controller 180 may terminate the output of the plurality of notification objects at a time, in response to a preset user input being applied.

FIG. 5 is a conceptual view illustrating an embodiment in which all notification icons are deleted, in response to a preset touch input.

Referring to FIG. 5, when events such as a messenger message reception, a missed call, an alarm, an SNS message reception, and a comment received on an SNS occur, icons corresponding to the respective events may be displayed on the screen 351.

Specifically, the icons may be output at the same time as those events occur. At this time, vibration or notification sound notifying the occurrence of the events may be output together with the icons.

Then, when a preset gesture is applied, for example, when the user applies a left or right swipe input 510 to the screen 351, all of the output icons may disappear simultaneously.

As another embodiment, currently-output icons may sequentially disappear along with a finger which applies the swipe input 510.

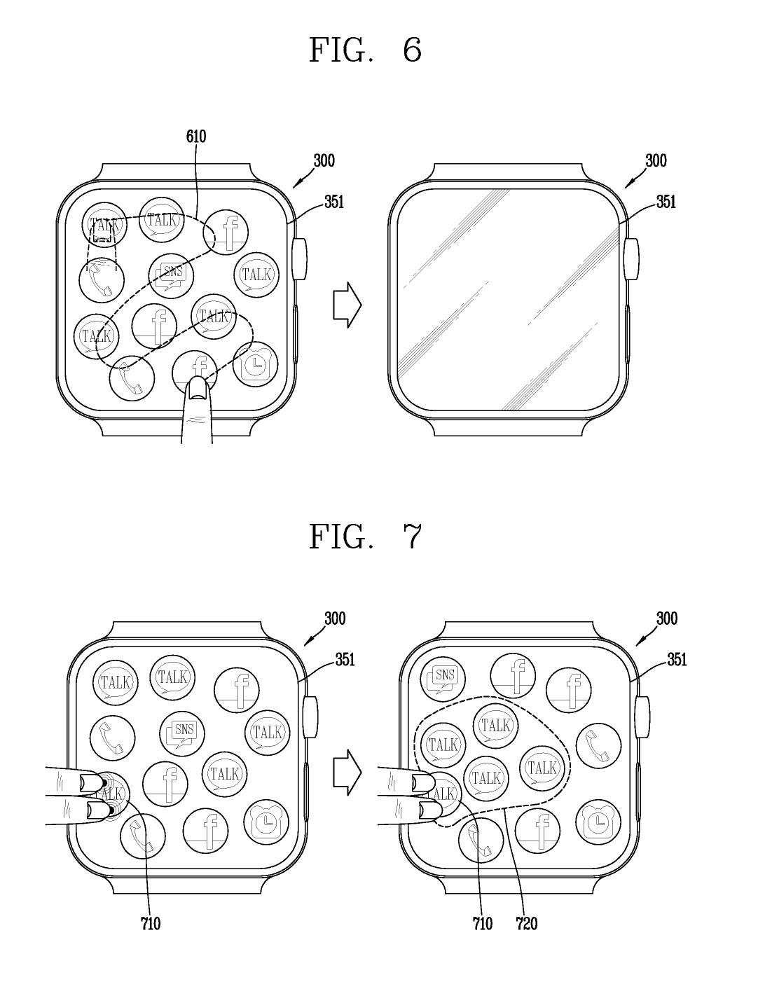

FIG. 6 is a conceptual view illustrating another embodiment in which all notification icons are deleted, in response to a preset touch input.

Referring to FIG. 6, when events such as a messenger message reception, a missed call, an alarm, an SNS message reception, a comment received on an SNS and the like occur, icons corresponding to the respective events may be displayed on the screen 351.

Specifically, the icons may be output at the same time as those events occur. At this time, vibration or notification sound notifying the occurrence of the events may be output together with the icons.

Then, when a preset gesture is applied, for example, when a user applies a touch input 610 like erasing with a finger to the screen 351, all of the output icons may disappear simultaneously.

As another embodiment, the output icons may sequentially disappear along with the finger applying the touch input 610. Specifically, those icons may sequentially disappear, starting from an icon to which a touch of rubbing the screen 351 with a finger is preferentially applied.

As described above, after the notification icons have disappeared, the screen 351 in an OFF state may be output or a home screen may be output.

Meanwhile, when a preset touch input is applied to a first notification object as one of a plurality of notification objects corresponding to events occurred in a first application, the controller 180 may arrange the remaining notification objects corresponding to the events occurred in the first application in a manner of being adjacent to the first notification object.

FIG. 7 is a conceptual view illustrating an embodiment in which specific notification icons are arranged adjacent to each other, in response to a preset touch input.

Referring to FIG. 7, when events such as a messenger message reception, a missed call, an alarm, an SNS message reception, a comment received on the SNS, and the like occur, icons corresponding to the respective events may be output on the screen 351.

Specifically, the icons may be output at the same time as those events occur. At this time, vibration or notification sound notifying the occurrence of the events may be output together with the icons.

Then, a preset gesture may be applied, for example, a long-touch input with two fingers may be applied to a message reception notification icon 710 in the first application.

Responsive to this, message reception notification icons in the first application displayed at various portions on the screen 351 may be arranged adjacent to the notification icon 710 and output on one area 720.

On the other hand, the controller 180 may arrange the plurality of notification objects according to an application in which the plurality of events have occurred, in response to a preset user input being applied.

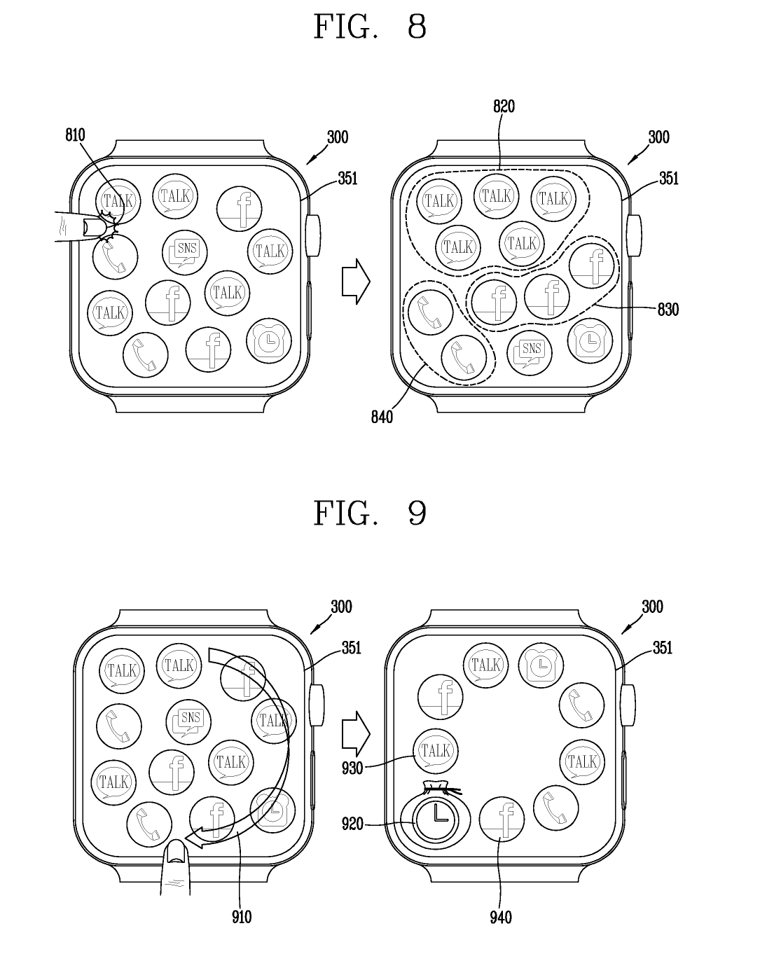

FIG. 8 is a conceptual view illustrating an embodiment in which notification icons are arranged for each application in which an event occurs, in response to a preset touch input.

Referring to FIG. 8, when events such as a messenger message reception, a missed call, an alarm, an SNS message reception, a comment received on the SNS, and the like occur, icons corresponding to the respective events may be output on the screen 351.

Specifically, the icons may be output at the same time as those events occur. At this time, vibration or notification sound notifying the occurrence of the events may be output together with the icons.

Then, a preset gesture may be applied, for example, a knock input (knock code input) may be applied to an area 810 in which any notification icon is not output.

Responsive to this, the notification icons that have been output in various places on the screen 351 may be output as a group for each application in which the events have occurred.

As an embodiment, message reception notification icons in the first application which includes the greatest number of notification icons currently output (i.e., in which the number of times of event occurrence is the greatest) may be output as one group in a first area 820 at a top of the screen 351.

In addition, notification icons of a second application which have the next greatest number of notification icons currently output may be output as one group in a second area 830, which is an area below the first area 820.

Similarly, notification icons of a third application which have the greatest number of notification icons currently output, next to the second application, may be output as one group in a third area 830, which is an area below the second area 830.

On the other hand, the controller 180 may arrange the plurality of notification objects according to a time order in which the plurality of events have occurred, in response to a preset user input being applied.

FIG. 9 is a conceptual view illustrating an embodiment in which notification icons are arranged according to an event-occurred time, in response to a preset touch input.

Referring to FIG. 9, when events such as a messenger message reception, a missed call, an alarm, an SNS message reception, a comment received on an SNS, and the like occur, icons corresponding to the respective events may be displayed on the screen 351.

Specifically, the icons may be output at the same time as those events occur. At this time, vibration or notification sound notifying the occurrence of the events may be output together with the icons.

Then, when a preset gesture is applied, for example, when a clockwise drag input 910 is applied to the screen 351 by the user, a clock-shaped icon 920 may be output. In addition, the notification icons that are currently output may be arranged according to an event-occurred time.

As an embodiment, only some of the currently-output notification icons may be output with forming a circle including the clock-shaped icon 920. Specifically, a first icon 940 corresponding to the most recently-occurred event may be output on a center at a bottom of the screen 351, and a second icon 930 corresponding to the earliest occurred event may be output above the clock-shaped icon 920.

On the other hand, the controller 180 may re-output at least one notification object whose output has been terminated due to a lapse of a preset time, in response to a preset user input being applied.

FIG. 10 is a conceptual view illustrating an embodiment in which deleted notification icons are output again, in response to a preset touch input.

As an embodiment following FIG. 9, referring to FIG. 10, a touch input 1010 like picking up a notification icon from the clock-shaped icon 920 may be applied. Accordingly, a notification icon that has been hidden due to being occurred early (i.e., having a low priority) may be output again.

As an embodiment, a third icon 1020 corresponding to an event occurred after the occurrence of an event corresponding to the second icon 930 may be output above the clock-shaped icon 920.

In another embodiment, an icon corresponding to an event having the highest priority among the notification icons hidden in FIG. 9 may also be output again.

Meanwhile, the controller 180 may output the plurality of notification objects in a preset manner based on priorities preset for the plurality of events.

FIG. 11 is a conceptual view illustrating an embodiment in which notification icons are output in a preset manner based on priorities.

Referring to FIG. 11, notification icons 1110, 1120, 1130, and 1140 corresponding to events having high priorities may be output larger than the other notification icons.

As an embodiment, the messenger message reception notification icon 1110 and the SNS message reception notification icon 1120 from a specific originator may be output larger than the other notification icons.

In another embodiment, when a received message includes a specific word or a sentence code, such as a question mark, requiring a reply, the message reception notification icon may be output larger than the other notification icons.

As another embodiment, the missed call notification icon 1130 from a specific originator or the notification icon 1140 of a schedule registered as an important schedule may be output larger than the other notification icons.

As another embodiment, when a message and a missed call are received from the same originator, each notification icon corresponding to the events may be output larger than the other notification icons.

As another embodiment, notification icons corresponding to events may be output in a three-dimensional (3D) space. In this case, a notification icon corresponding to an event having a high priority may be output larger and closer than the other notification icons.

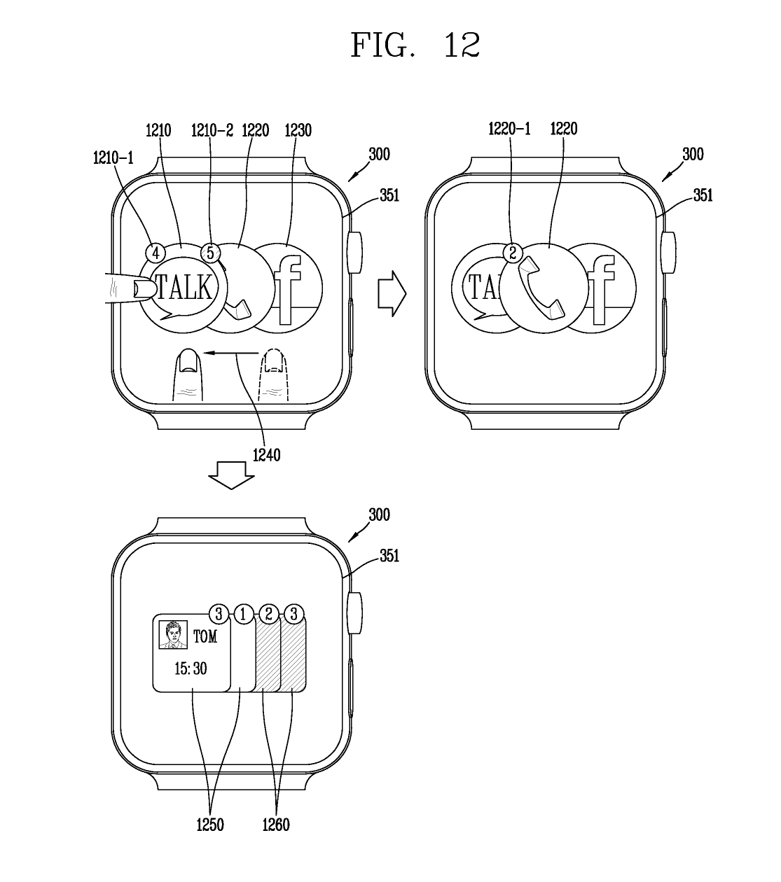

FIG. 12 is a conceptual view illustrating an embodiment in which contents of occurred events are output based on priorities.

Referring to FIG. 12, notification icons 1210, 1220, and 1230 indicating occurrence of events in a specific application may be output in a partially overlapped manner. At this time, the number of times of occurrence of an event with a high priority among the events occurred in the corresponding application may be displayed in a distinguishable manner.

As an embodiment, a first notification icon 1210 for notifying an event occurrence in a first application may be output, and a number of times 1210-1 of occurrence of an event with a high priority may be output on an upper left side of the first notification icon 1210. In addition, a number of times 1210-2 of occurrence of an event with a relatively low priority may be output on an upper right side. The high and low priorities may be preset by the user. Detailed embodiments related to this will be described later.

As another embodiment, when a drag input 1240 to the left is applied, a second notification icon 1220 indicating occurrence of an event in a second application, which has been output below the first notification icon 1210, may preferentially be output as an upper icon (on an upper layer) on a center of the screen 351. Similarly, a number of times 1220-1 of occurrence of an event having a high priority may be output on an upper left end of the second notification icon 1220.

In another embodiment, when a touch input is applied to the first notification icon 1210, contents of events generated in the first application may be output according to priorities.

Specifically, a content 1250 of an event, which has been output on the upper left end of the first notification icon 1210 with the number of times 1210-1 of the occurrence of the event with the higher priority, may be output preferentially (on an upper layer).

For example, a content of a message received from an originator A with a high priority may be output on an upper layer, and a content of a message received from an originator B with a next high priority may be output on the next layer.

Likewise, a content 1260 of an event, which has been output on the upper right end of the first notification icon 1210 with the number of times 1210-2 of the occurrence of the event with the relatively low priority, may be output on a lower layer.

For example, contents of received messages may be output on different layers for each originator. As an embodiment, messages except for a message received from an originator with a high priority may be arranged according to a received time. Alternatively, an advertisement message may be output on the lowest layer.

On the other hand, the controller 180 may output a plurality of notification icons corresponding to a plurality of events for receiving data, in response to occurrence of the plurality of events.

In addition, the controller 180 may switch the plurality of notification icons into icons corresponding to data senders, in response to a preset user input being applied.

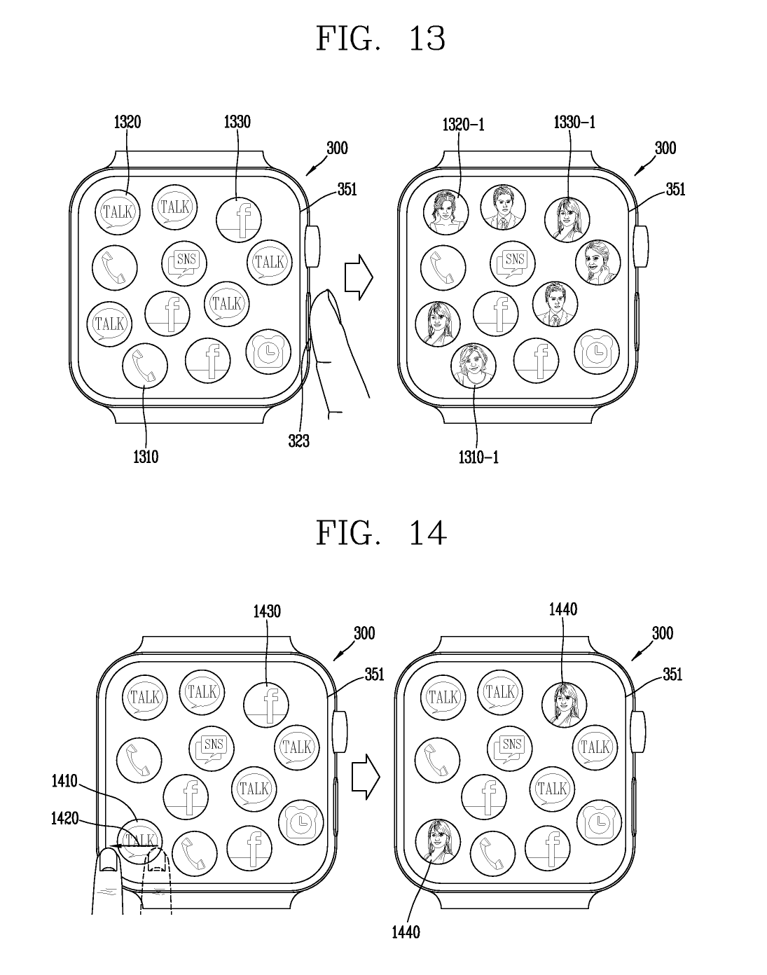

FIG. 13 is a conceptual view illustrating an embodiment in which a photograph (an image) of a message sender is output, in response to a preset user input.

Referring to FIG. 13, when events such as a messenger message reception, a missed call, an alarm, an SNS message reception, a comment received on the SNS, and the like occur, icons corresponding to the respective events may be output on the screen 351.

Specifically, the icons may be output at the same time as those events occur. At this time, vibration or notification sound notifying the occurrence of the events may be output together with the icons.

Then, when a preset user input is applied, for example, when a push input is applied to the user input unit 323, a data reception notification icon may be switched into a photo image of an originator who has sent the data.

As an embodiment, when a push input is applied to the user input unit 323, a missed call notification icon 1310 may be switched into a photo image 1310-1 of an originator who has placed the missed call.

As another embodiment, when a push input is applied to the user input unit 323, a messenger message reception notification icon 1320 may be switched into a photo image 1320-1 of an originator of the messenger message.

As another embodiment, when a push input is applied to the user input unit 323, an SNS comment notification icon 1330 may be switched into a photo image 1330-1 of a user who has left the comment.

On the other hand, the controller 180 may switch a notification icon corresponding to a data reception event from a specific originator into an icon corresponding to the specific originator, in response to a preset user input being applied.

FIG. 14 is a conceptual view illustrating an embodiment in which a data reception notification icon from a specific sender is switched to a photograph (an image) of the specific sender, in response to a preset touch input.

Referring to FIG. 14, when events such as a messenger message reception, a missed call, an alarm, an SNS message reception, a comment received on an SNS, and the like occur, icons corresponding to the respective events may be displayed on the screen 351.

Specifically, the icons may be output at the same time as those events occur. At this time, vibration or notification sound notifying the occurrence of the events may be output together with the icons.

Then, when a swipe input 1420 to the left is applied to a message reception notification icon 1410 of a first application, a notification icon 1410 may be switched into an image 1440 of an originator A who has sent the message.

At this time, when the originator A uploads a post on a second application, a notification icon 1430 of the second application corresponding to the uploading of the post by the originator A may also be switched into an image 1440 of the originator A.

That is, according to the embodiment of FIG. 14, contents of events generated by the same originator can be easily confirmed.

On the other hand, the controller 180 may switch a notification icon corresponding to a data reception event generated in a specific application into an icon corresponding to an originator of the data, in response to a preset user input being applied.

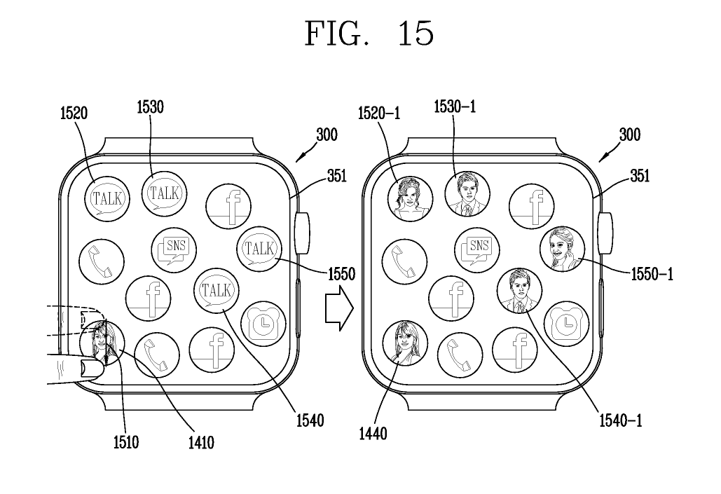

FIG. 15 is a conceptual view illustrating an embodiment in which a data reception notification icon in a specific application is switched to a photograph of an originator, in response to a preset touch input.

Referring to FIG. 15, when events such as a messenger message reception, a missed call, an alarm, an SNS message reception, a comment received on an SNS, and the like occur, icons corresponding to the respective events may be displayed on the screen 351.

Specifically, the icons may be output at the same time as those events occur. At this time, vibration or notification sound notifying the occurrence of the events may be output together with the icons.

As an embodiment, message reception events may occur in a first application, and icons 1410, 1520, 1530, 1540, and 1550 corresponding to those events may be output.

Then, when a downward swipe input 1510 is applied to the first notification icon 1410, which is one of the icons, the first notification icon 1410 may be switched into an image 1440 of the originator A who has sent the message.

Similarly, the remaining icons 1520, 1530, 1540, and 1550 corresponding to the message reception events in the first application may also be switched into images 1520-1, 1530-1, 1540-1, and 1550-1 of originators who have sent the corresponding messages.

That is, according to the embodiment of FIG. 15, a person (a message originator) associated with an occurred event can be easily confirmed, with respect to a specific application.

On the other hand, the controller 180 may sequentially terminate the output of the plurality of notification icons based on priorities preset for the plurality of events.

At this time, the controller 180 may sequentially terminate the output of the plurality of notification icons, based on at least one of a data originator, presence or absence of preset data, and occurrence or non-occurrence of an event in a preset application, with respect to the plurality of events.

As an embodiment, the controller 180 may sequentially terminate the output of the plurality of notification icons in response to a lapse of a preset time.

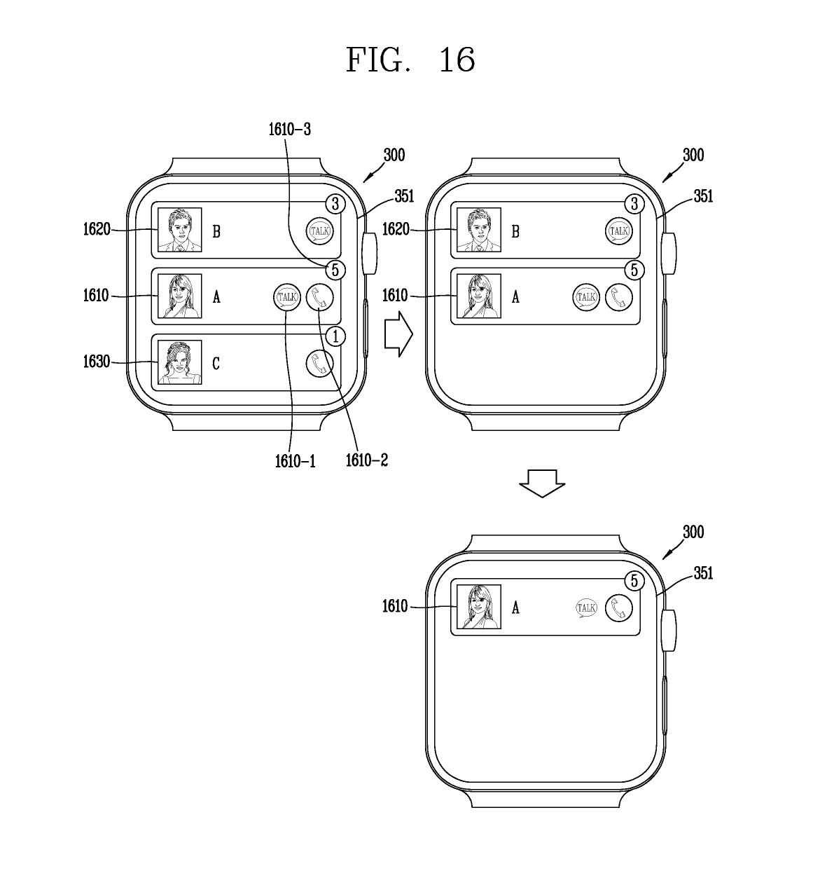

FIG. 16 is a conceptual view illustrating an embodiment in which a notification menu disappears based on a number of times of occurrence of a data reception event.

Referring to FIG. 16, a data reception notification menu 1610 from A, a data reception notification menu 1620 from B, and a data reception notification menu 1630 from C may be displayed on the screen 351.

More specifically, the data reception notification menu 1610 from A may include a messenger message reception notification icon 1610-1 from A, a missed call notification icon 1610-2 from A, and a number of data 1610-3 received from A may be displayed. Specifically, the number of data 1610-3 received from A may be a total of the number of messenger messages received from A and the number of missed calls from A.

Similarly, the data reception notification menu 1620 from B may include a messenger message reception notification icon from B and a number of messenger messages received from B. In addition, the data reception notification menu 1630 from C may include a missed call notification icon from C and a number of missed calls from C.

As a related embodiment, the currently-output notification menus 1610, 1620, and 1630 may disappear sequentially from the screen 351 according to a number of times of occurrence of the events. At this time, vibration and notification sound may be output at the same time of the sequential disappearing of the menus.

Specifically, after a lapse of a preset time, the data reception notification menu 1630 from C from which a missed call has been received first disappears from the screen 351. Then, after the preset time has elapsed again, the data reception notification menu 1620 from B from which three messenger messages have been received disappears. Accordingly, only the data reception notification menu 1610 from A, in which a total of the number of received messenger messages and the number of missed calls is five, is left on the screen 351.

That is, a notification menu having a less number of received data preferentially disappears from the screen 351. As a result, a notification menu from an originator who has often made contact is displayed for the longest time.

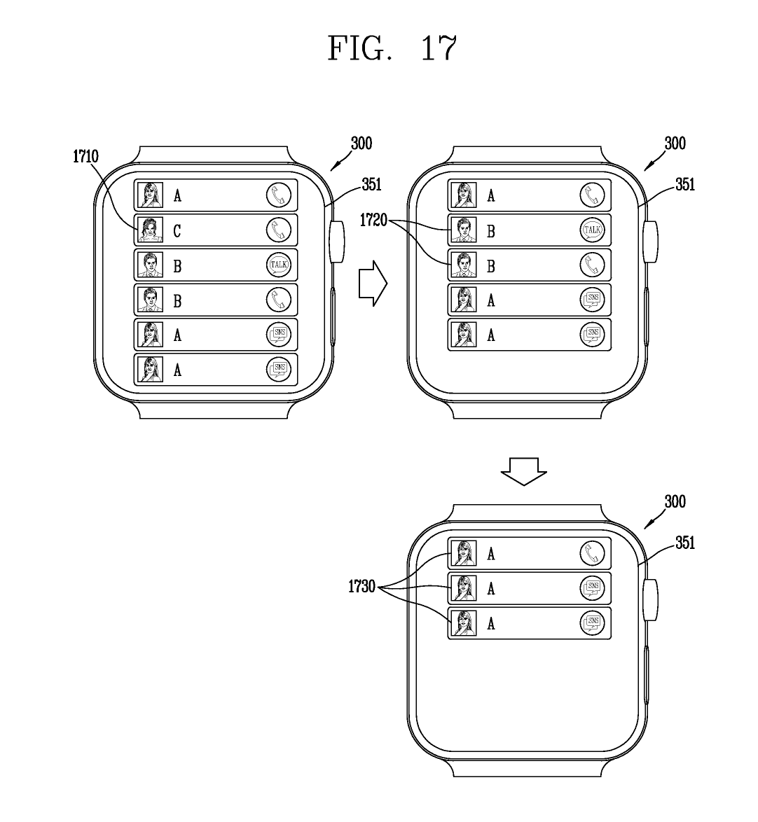

FIG. 17 is a conceptual view illustrating an embodiment in which a notification menu disappears based on a priority of an originator.

Referring to FIG. 17, notification menus corresponding to data reception events may be output according to a time order in which the data reception events have occurred. As an embodiment, when data reception events occur, notification menus corresponding to the events are output on the screen 351 from top to bottom.

More specifically, a missed call notification menu from A, a missed call notification menu from C, a messenger message reception notification menu from B, a missed call notification menu from B, an SNS message reception notification menu from A, and another SNS message reception notification menu from A may be output sequentially on the screen 351.

On the other hand, priorities (importance) of message reception events may be determined for each originator. As an embodiment, priorities may be set in the order of A, B, and C.

Accordingly, when a preset time elapses, the data reception notification menu 1710 from C having the lowest priority disappears from the screen 351 first. Then, when the preset time elapses again, the data reception notification menu 1720 from B having the next lowest priority disappears from the screen 351. That is, only the data reception notification menu 1730 from A having the highest priority is displayed on the screen 351.

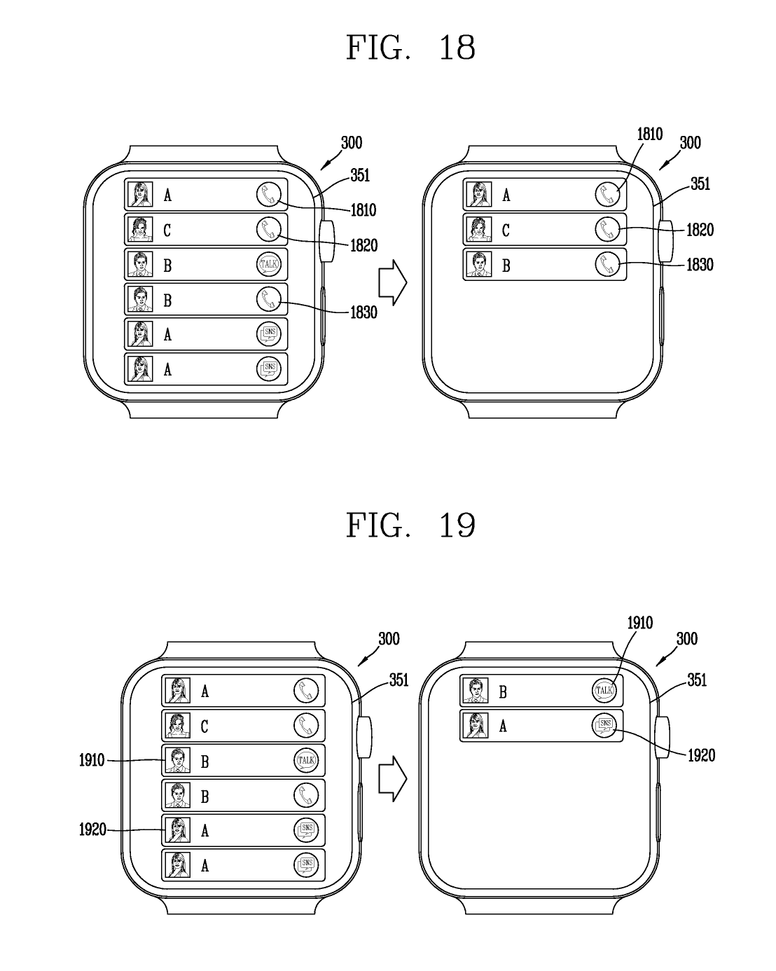

FIG. 18 is a conceptual view illustrating an embodiment in which only a notification menu of an event occurred in a specific application is left.

Referring to FIG. 18, as illustrated in FIG. 17, notification menus corresponding to data reception events may be output according to a time order in which the data reception events have occurred. As an embodiment, when data reception events occur, notification menus corresponding to the events are output on the screen 351 from top to bottom.

More specifically, a missed call notification menu from A, a missed call notification menu from C, a messenger message reception notification menu from B, a missed call notification menu from B, an SNS message reception notification menu from A, and another SNS message reception notification menu from A may be output sequentially on the screen 351.

On the other hand, priorities (importance) of the message reception events may be determined depending on a type of an application in which a message reception event has occurred. As an embodiment, the highest priority may be set for a missed call.

Accordingly, after a lapse of a preset time, only missed call reception notification menus 1810, 1820, and 1830 are displayed on the screen 351.

As another embodiment, when priorities are set in the order of originators A, B, and C, the missed call reception notification menus 1810, 1820, and 1830 disappear from the screen 351 based on the set priorities.

Specifically, after a lapse of a preset time, the missed call reception notification menu 1820 from the C disappears from the screen 351, and then the missed call reception notification menu 1830 from B disappears from the screen 351.

FIG. 19 is a conceptual view illustrating an embodiment in which only a data reception notification menu including a specific word is left.

Referring to FIG. 19, as described in FIG. 17, notification menus corresponding to data reception events may be output according to a time order in which the data reception events have occurred. As an embodiment, when data reception events occur, notification menus corresponding to the events are output on the screen 351 from top to bottom.

More specifically, a missed call notification menu from A, a missed call notification menu from C, a messenger message reception notification menu from B, a missed call notification menu from B, an SNS message reception notification menu from A, and another SNS message reception notification menu from A may be output sequentially on the screen 351.

On the other hand, priorities (importance) may be determined depending on whether or not a specific word is included in received messages. As an embodiment, a first message reception notification menu 1910 and a second message reception notification menu 1920 which include a preset specific word are merely output on the screen 351.

As another embodiment, a higher priority may be set for a message reception notification menu including a specific word more times. Specifically, after a preset time elapses, only the second message reception notification menu 1920 including the specific words several times is output on the screen 351.

On the other hand, the controller 180 may sequentially terminate the output of the plurality of notification icons, in response to a preset user input being applied.

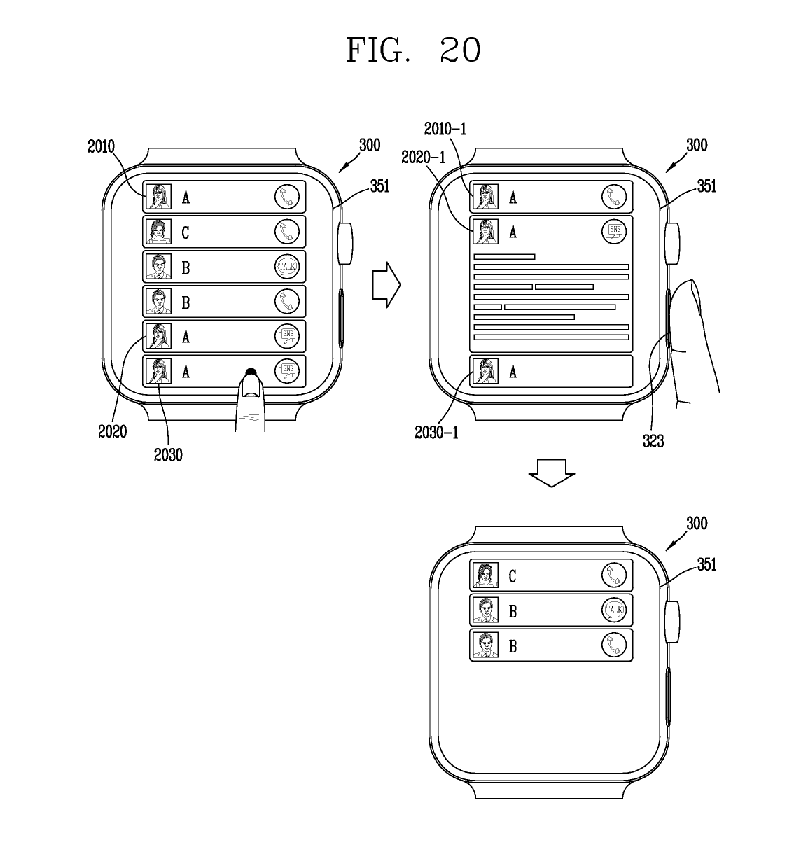

FIG. 20 is a conceptual view illustrating an embodiment in which a notification menu disappears in response to contents of received data being confirmed.

Referring to FIG. 20, as described in FIG. 17, notification menus corresponding to data reception events may be output according to a time order in which the data reception events have occurred. As an embodiment, when data reception events occur, notification menus corresponding to the events is output on the screen 351 from top to bottom.

Specifically, a missed call notification menu 2010 from A, a missed call notification menu from C, a messenger message reception notification menu from B, a missed call notification menu from B, an SNS message reception notification menu 2020 from A, and another SNS message reception notification menu 2030 from A may be output sequentially on the screen 351.

At this time, when a touch input is applied to the another SNS message reception notification menu 2030 from A, concrete contents 2010-1, 2020-2, and 2030-1 of data received from A may be output.

As an embodiment, a received date, a received time, etc. (2010-1) of the missed call from A may be output. Also, the date, the time, and the concrete contents 2020-1 and 2030-1 of the SNS message received from A may be output.

As another embodiment, the user may confirm the concrete contents 2010-1, 2020-2, and 2030-1 in a turn-over manner by applying an upward or downward flicking input (scroll input).

Thereafter, when a user input is not applied for a preset time or an input is applied to the user input unit 323, only notification menus corresponding to data reception events of which detailed contents have not been confirmed yet may be output. That is, only the missed call notification menu from C, the messenger message reception notification menu from B, and the missed call notification menu from B are left on the screen 351.

On the other hand, the same menus as those on the screen 351 of the watch-type terminal 300 may be output on the screen 151 of the smart phone 100 which communicates with the watch-type terminal 300. Embodiments related thereto will be described.

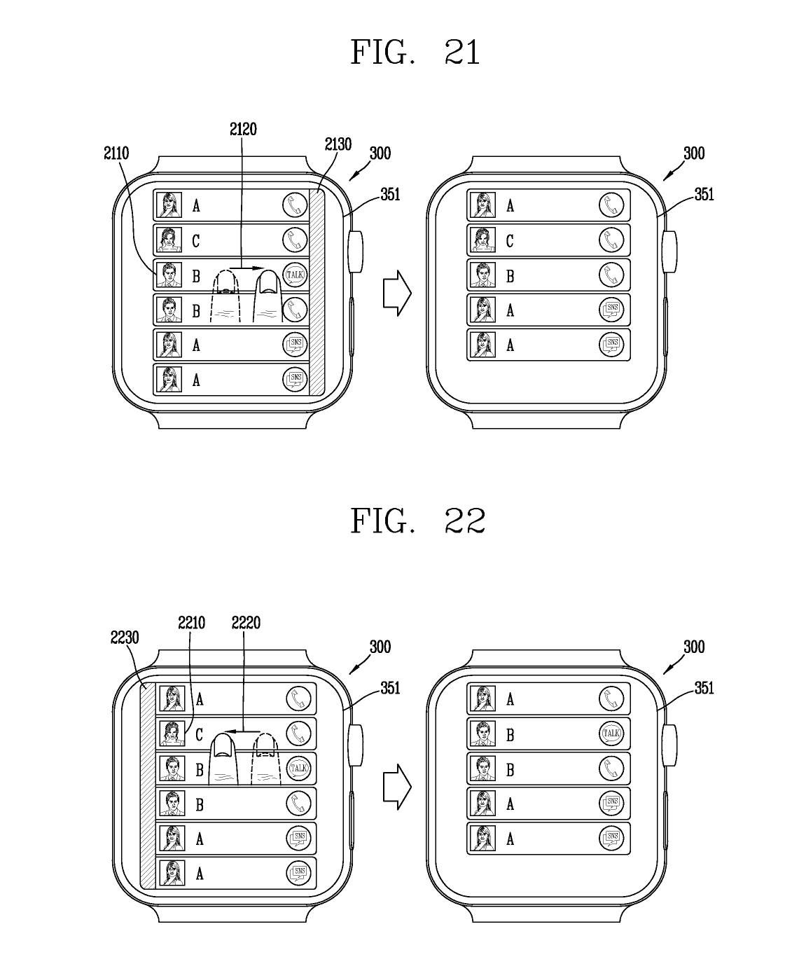

FIG. 21 is a conceptual view illustrating an embodiment in which a currently-output notification menu disappears only from a watch-type mobile terminal, in response to an input of a preset touch input.

Referring to FIG. 21, as described in FIG. 17, notification menus corresponding to data reception events may be output according to a time order in which the data reception events have occurred. As an embodiment, when data reception events occur, notification menus corresponding to the events are output on the screen 351 from top to bottom.

More specifically, a missed call notification menu from A, a missed call notification menu from C, a messenger message reception notification menu 2110 from B, a missed call notification menu from B, an SNS message reception notification menu from A, and another SNS message reception notification menu from A may be output sequentially on the screen 351.

On the other hand, the same notification menus may also be output on the smart phone 100 communicating with the watch-type terminal 300. At this time, when a swipe input 2120 to the right is applied to the messenger message reception notification menu 2110 from B, a specific area 2130 may be output on the right of the screen 351. This is merely illustrative, and a trashcan icon may alternatively be displayed to indicate a deletion of a corresponding icon.

As the swipe right input 2120 to the right is applied, the messenger message reception notification menu 2110 from B may be deleted from the screen 351 of the watch-type terminal 300, and may continuously output on the screen 141 of the smart phone 100.

FIG. 22 is a conceptual view illustrating an embodiment in which a currently-output notification menu disappears from both of a watch-type mobile terminal and a smart phone, in response to an input of a preset touch input.

Referring to FIG. 22, as described in FIG. 21, notification menus corresponding to data reception events may be output according to a time order in which the data reception events have occurred. As an embodiment, when data reception events occur, notification menus corresponding to the events are output on the screen 351 from top to bottom.

Specifically, a missed call notification menu from A, a missed call notification menu 2210 from C, a messenger message reception notification menu from B, a missed call notification menu from B, an SNS message reception notification menu from A, and another SNS message reception notification menu from A may be output sequentially on the screen 351.

On the other hand, the same notification menus may also be output on the smart phone 100 communicating with the watch-type terminal 300. At this time, when a swipe input 2220 to the left is applied to the missed call notification menu 2210 from C, a specific area 2230 may be output on the left of the screen 351. This is merely illustrative, and a trashcan icon may alternatively be displayed to indicate a deletion of a corresponding icon.

As the swipe input 2220 to the left is applied, the missed call notification menu 2210 from C may be deleted from both of the screen 351 of the watch-type terminal 300 and the screen 151 of the smart phone 100.

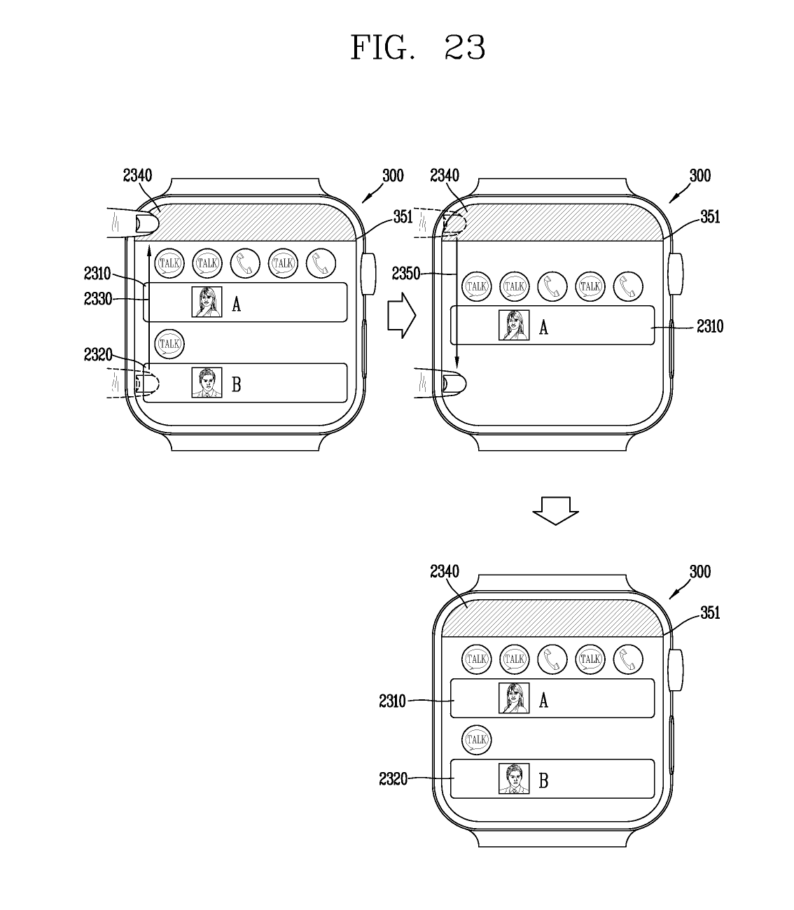

FIG. 23 is a conceptual view illustrating an embodiment in which a currently-output notification menu disappears in response to a preset touch input.

Referring to FIG. 23, a data reception notification menu 2310 from A and a data reception notification menu 2320 from B may be output. At this time, the notification menus 2310 and 2320 may include icons of applications in which the data reception events from A or B have occurred. Specifically, when a messenger message is received from B, a notification icon corresponding to a messenger application may be output.

Subsequently, when an upward drag input 2330 is applied to the data reception notification menu 2320 from B, a specific area 2340 may be output on a top of the screen 351. This is merely illustrative, and a trashcan icon may alternatively be displayed to indicate a deletion of a corresponding icon. In addition, the data reception notification menu 2320 from B to which the drag input 2330 has been applied may be deleted from the screen 351.

As another embodiment, when a downward drag input 2350 is applied to the specific area 2340 output on the top of the screen 351, the data reception notification menu 2320 from be which has been deleted may be output again on the screen 351.

Hereinafter, effects of a mobile terminal and a method of controlling the same according to the present invention will be described.

According to at least one of the embodiments of the present invention, since event occurrence notification icons disappear based on their priorities, a user cannot miss important notification.

In addition, according to at least one of the embodiments of the present invention, as a message reception notification icon is switched into a photo image of a message originator, the message originator can be intuitively confirmed.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1-20. (canceled)

21. A watch-type mobile terminal, comprising:
a display; and
a controller configured to:
cause the display to display a plurality of notification objects corresponding to an occurrence of a respective plurality of events; and
sequentially terminate the displaying of each of the plurality of notification objects based on a preset priority of each of the plurality of events.

22. The terminal of claim 21, wherein the controller is further configured to:
cause output of at least one of a preset vibration or sound in association with the terminating the displaying of each of the plurality of notification objects.

23. The terminal of claim 21, wherein the controller is further configured to:
setting a degree of priority in response to a user input; and
cause the display to display only those notification objects having the degree of priority.

24. The terminal of claim 21, wherein the controller is further configured to:
cause the display to display a further plurality of notification objects corresponding to an occurrence of a respective further plurality of events; and
terminate the displaying of all of the further plurality of notification objects in response to receiving of a user input.

25. The terminal of claim 21, wherein the controller is further configured to:
when a touch input is applied to a first notification object of the plurality of notification objects, arrange remaining notification objects, of the plurality of notification objects, to be displayed adjacent to the first notification object, wherein the first notification object and the remaining notification objects are those objects that relate to a same first application.

26. The terminal of claim 21, wherein the controller is further configured to:
arrange the plurality of notification objects on the display according to respective applications in which the plurality of events have occurred, in response to a user input.

27. The terminal of claim 21, wherein the controller is further configured to:
arrange the plurality of notification objects on the display in order of a respective time at which each of the plurality of events occurred, in response to a user input.

28. The terminal of claim 21, wherein the controller is further configured to:
cause the display to display at least one of the plurality of notification objects, after the terminating of the displaying of each of the plurality of notification objects, in response to a user input.

29. The terminal of claim 21, wherein the controller is further configured to:
cause the display to display the plurality of notification objects in a preset manner based on the preset priority of each of the plurality of events.

30. The terminal of claim 21, wherein the controller is further configured to:
cause the display to display a second plurality of notification objects corresponding to an occurrence of a respectively plurality of events of receiving data, in response to the occurrence of the plurality of events of receiving data.

31. The terminal of claim 30, wherein the controller is further configured to:
switch each of the second plurality of notification icons to an icon respectively corresponding to a data originator that has sent the data which has been received, in response to a user input.

32. The method of claim 30, wherein the controller is further configured to:
switch a notification icon of the second plurality of notification icons to an icon corresponding to a specific originator that has sent the data which has been received, in response to a user input.

33. The terminal of claim 30, wherein the controller is further configured to:
switch a notification icon, of the second plurality of notification icons, that corresponds to the event of receiving data and which occurs in a specific application, to an icon corresponding to a specific originator that has sent the data which has been received, in response to a user input.

34. The terminal of claim 30, wherein the controller is further configured to:
sequentially terminate the displaying of each of the second plurality of notification objects based on a preset priority of each of the plurality of events of receiving data.

35. The terminal of claim 34, wherein the controller is further configured to:
sequentially terminate the displaying of each of the second plurality of notification objects further based on at least one of a data originator, presence or absence of preset data, or occurrence or non-occurrence of an event in a preset application, with regard to a respective one of the plurality of events of receiving data.

36. The terminal of claim 30, wherein the controller is further configured to:
sequentially terminate the displaying of each of the second plurality of notification objects, in response to a lapse of a preset time.

37. The terminal of claim 30, wherein the controller is further configured to:
sequentially terminate the displaying of each of the second plurality of notification objects, in response to a user input.

38. A method for controlling a watch-type mobile terminal having a display, the method comprising:
displaying, on the display, a plurality of notification objects corresponding to an occurrence of a respective plurality of events; and
sequentially terminating the displaying of each of the plurality of notification objects based on a preset priority of each of the plurality of events.

39. The method of claim 38, further comprising:
displaying, on the display, a second plurality of notification objects corresponding to occurrence of a respectively plurality of events of receiving data, in response to occurrence of the plurality of events of receiving data.

40. The method of claim 39, further comprising:
sequentially terminating the displaying of each of the second plurality of notification objects based on a preset priority of each of the plurality of events of receiving data.
